(19) United States
(12) Patent Application Publication
(10) Pub. No.: US 2014/0047964 A1
(43) Pub. Date: Feb. 20, 2014

(54) Food Slicer

(71) Applicant: Gang Zhao, College Station, TX (US)

(72) Inventor: Gang Zhao, College Station, TX (US)

(21) Appl. No.: 13/589,110

(22) Filed: Aug. 18, 2012

(51) Int. Cl. B26D 3/28; B26D 7/02

(52) U.S. Cl. CPC B26D 3/28; B26D 7/02
USPC 83/167; 83/452; 83/465; 83/453

(57) ABSTRACT

A food slicer for slicing food, comprising: a housing, a cutting board with generally curved cutting surface mounted inside the housing, a cutting blade oriented generally transverse to the cutting direction having a peripheral cutting edge and defining a blade plane, an electric drive motor for drivingly rotating the cutting blade of the food slicer, a first slider slidable along a first guide rail which is oriented generally parallel to the cutting direction, a first spring connected between the first slider and the housing for propelling the first slider toward the cutting board, so the first slider pushes the food articles toward the cutting board for preventing the food articles on the cutting board from moving. The food slicer further includes a board pivotally mounted in the housing with surface oriented generically parallel to the blade plane for supporting the unsliced food articles.

This invention relates to a food slicer and, more particularly, to an electric slicing device particularly designed to store, cut and serve food slices of various configurations.

Food products of various types are often provided in large chunks or loaves that are typically sliced into relatively thin slices. For example, “deli” type meat products are usually provided in elongated loaf type form, and slices are cut from the end of the loaf as required. The same is true of many cheeses or vegetables. While bread loaves can be bought in either cut or uncut form, most bread purchased in grocery stores might be pre-sliced, or the purchaser could have the store or bakery slice the bread if so desired. However, if the bread is not sliced at the store or bakery, or if the bread is home baked, then the user must cut slices in order to use the bread.

While specialized slicers are used in commercial establishments for slicing meat, fruits or vegetables, these slicers are relatively large, motorized products which are not generally suitable for home use. Many meat slicers include a rotatable, motorized cutting blade with the loaf of meat being held against the cutting blade and moved back and forth across the blade to cut sequentially slices of meat off the end of the loaf Bread slicers often include a plurality of vertical, reciprocating saw blades spaced apart by the thickness of the desired slices, with the bread loaf being pushed through the saw blades to slice the entire loaf in one action. Again, these slicers are generally too expensive for home use.

In addition, cutting an entire loaf of bread all at once is disadvantageous if the bread is not consumed quickly, particularly for home baked bread lacking preservatives, since the bread tends to dry out rapidly. It would be better to cut off just individual slices as needed and leave the rest of the bread loaf intact.

Obviously, a loaf of food could be cut simply by holding the loaf of food in place with one hand and using the other hand to manipulate a knife to cut slices off the end of the loaf. However, this is not ideal for a number of reasons. Gripping the loaf tightly with the hand tends to crush the food while it is being cut. In addition, it is difficult to cut slices having a consistent thickness, or to adjust easily the thickness of the sliced food, simply using an unsupported knife. Finally, if the user is not careful, there is a possibility that the user might accidentally cut his or her fingers with the knife blade.

Various devices are known for use with a tube or cup to help hold a loaf of food when slicing the food manually. U.S. Pat. No. 7,337,997, U.S. Pat. No. 7,866,243 and U.S. Pat. No. 7,694,615 are this type. These devices do help the users to cut food and release the possibility to cut his or her fingers; however, it is still strenuous for user to cut food since the user need to great effort to slice food.

Accordingly, there has been a need for an automatic, small food slicer for home use.

### SUMMARY

The application described here is an improved food slicer which can automatically cut vegetable, fruit, sausage and meat into even thickness for home, restaurant, hotel and factory use.

In particular, there is described a food slicer which has a cutting board with curved cutting surface and a first slider slidable along a first guide rail which is oriented generally parallel to the cutting direction. The slider pushes the food articles to the cutting board to prevent the food articles from moving when the cutting blade cuts the food articles, and releases the food articles when the cutting blade has finished one cutting process.

Another aspect is that the food slicer has a feed tube and a board pivotally mounted in the housing with surface oriented generically parallel to the blade plane for supporting the food articles. The board is rotated to the bottom of the feed tube by a spring which connected between the board and the housing to prevent the food articles from falling down when the slider releases the food articles; the board is moved away from the bottom of the feed tube by a block which is mounted on the top surface of the cutting blade when the slider holds the food articles. Since the surfaces of cutting blade and the board are parallel, the food slicer can cut the food evenly. Further, because the distance between the board and cutting blade is adjustable, the thickness of sliced food articles is adjustable.

Specifically, there has been described a food slicer comprising: a housing, a cutting board with generally curved cutting surface mounted inside the housing, a cutting blade oriented generally transverse to the cutting direction having a peripheral cutting edge and defining a blade plane, an electric drive motor for drivingly rotating the cutting blade of the food slicer, a first slider slidable along a first guide rail which is oriented generally parallel to the cutting direction, a first spring connected between the first slider and the housing for propelling the first slider toward the cutting board, so the first slider pushes the food articles toward the cutting board for preventing the food articles on the cutting board from moving. The food slicer further includes a lid for covering the housing, the lid defining a feed tube opening permitting access to within the housing, a feed tube extending from a top wall of the lid, the feed tube defining a feed cavity and including a feed mouth, a board pivotally mounted in the housing with surface oriented generically parallel to the blade plane for supporting the food articles, a second spring connected between the board and the housing for propelling the board to rotate toward the bottom of feed tube, a first block mounted on the top surface of the cutting blade for driving the first slider away from the cutting board and a second block mounted on the bottom surface of the cutting blade for driving the board.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the food slicer of the present invention;

FIG. 2 illustrates a perspective view of the lid of the food slicer of the present invention;

FIG. 3 illustrates a perspective view of the lid of the food slicer of the present invention;

FIG. 4 illustrates a perspective view of the main body member of the food slicer of the present invention;

FIG. 5 illustrates a perspective view of the housing of the food slicer of the present invention;

FIG. 6 illustrates a top view of the housing of the food slicer of the present invention;

FIG. 7 illustrates a perspective view of the slicing device of the present invention;

FIG. 8 illustrates a top view of the slicing device of the present invention;

FIG. 9 illustrates an exploded view of the slicing device of the present invention;

FIG. 10 illustrates a perspective view of the cutting assembly of the present invention;

FIG. 11 illustrates a top view of the cutting assembly of the present invention;

FIG. 12 illustrates a top view of the slider assembly of the present invention;

FIG. 13 illustrates a perspective view of the slider assembly of the present invention;

FIG. 14 illustrates a top view of the associate slider of the present invention;

FIG. 15 illustrates a perspective view of the support assembly of the food slicer of the present invention;

FIG. 16 illustrates a top view of the support assembly of the food slicer of the present invention;

FIG. 17 illustrates a top view of the support assembly of the food slicer of the present invention;

FIG. 18 illustrates the operation of the food slicer of the present invention;

FIG. 19 illustrates the operation of the food slicer of the present invention;

FIG. 20 illustrates the operation of the food slicer of the present invention;

FIG. 21 illustrates an exploded view of the entire food slicer of the present invention.

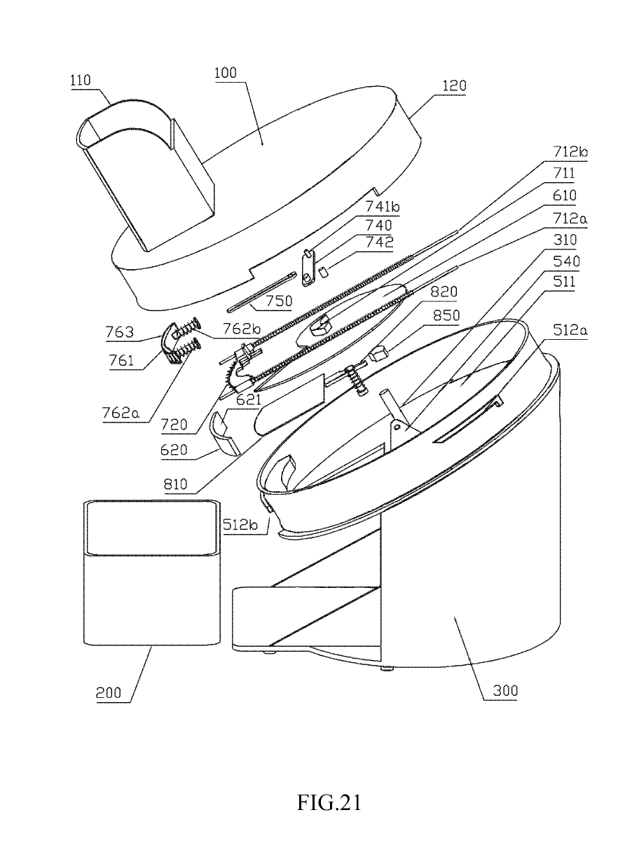

### DETAILED DESCRIPTION

The food slicer described in this invention is a machine to cut food articles (fresh meat, sausage, vegetable, fruit and so on) into slices for family, hotel, restaurant and factory use. The food slicer includes a housing, a cutting board with generally curved cutting surface mounted inside the housing, a cutting blade oriented generally transverse to the cutting direction having a peripheral cutting edge and defining a blade plane, an electric drive motor for drivingly rotating the cutting blade of the food slicer, a first slider slidable along a first guide rail which is oriented generally parallel to the cutting direction, a first spring connected between the first slider and the housing for propelling the first slider toward the cutting board, a lid for covering the housing and defining a feed tube opening permitting access to within the housing, a feed tube extending from a top wall of the lid, a board pivotally mounted in the housing with surface oriented generically parallel to the blade plane for supporting the food articles, a second spring connected between the board and the housing for propelling the board to rotate toward the bottom of the feed tube, a first block mounted on the top surface of the cutting blade for driving the first slider away from the cutting board, a second block mounted on the bottom surface of the cutting blade for driving the board away from the bottom of the feed tube, a second slider slidable along a second guide rail which is oriented generally parallel to the cutting direction and mounted on the first slider, a third spring connected between the first slider and the second slider for propelling the second slider toward the cutting board , a receptacle, a pusher for pushing the food articles in the feed tube down to the cutting blade, and some other parts. Different from other food slicer or food processor, the food slicer described in this invention has several features:
1) A cutting board with curved cutting surface;
2) A first slider slidable along a first guide rail which is oriented generally parallel to the cutting direction for preventing the food articles from moving when the cutting blade cuts the food articles on the cutting board;
3) A second slider slidable along a second guide rail which is oriented generally parallel to the cutting direction and mounted on the first slider;
4) A board pivotally mounted in the housing with surface oriented generically parallel to the blade plane for supporting the food articles;
5) A first block mounted on the top surface of the cutting blade for driving the first slider away from the cutting board;
6) A second block mounted on the bottom surface of the cutting blade for driving the board away from the bottom of the feed tube;

While the present invention will be fully described hereinafter with reference to the accompanying drawings, in which particular embodiments are shown, it is to be understood at the outset that persons skilled in the art may modify the embodiments disclosed herein while still achieving the desired result. Accordingly, the description that follows is to be understood as a broad informative disclosure directed to persons skilled in the appropriate art and not as limitations of the present disclosure.

The invention provides an efficient, automatically device to cut food articles (fresh meat, sausage, vegetable, fruit and other types of foods) into slices for use in the home or commercially.

When food articles are sliced by hand, the user may require a knife, a cutting board, the left hand to hold the food articles onto the cutting board, and the right hand to manipulate the knife to cut the food articles. The present invention simulates this cutting process with a mechanism which may include a cutting blade, a cutting board with curved cutting surface, a slider with teeth edge to hold the food articles on the cutting board when the cutting blade cuts the food articles, and a power supply device including a motor for driving the cutting blade.

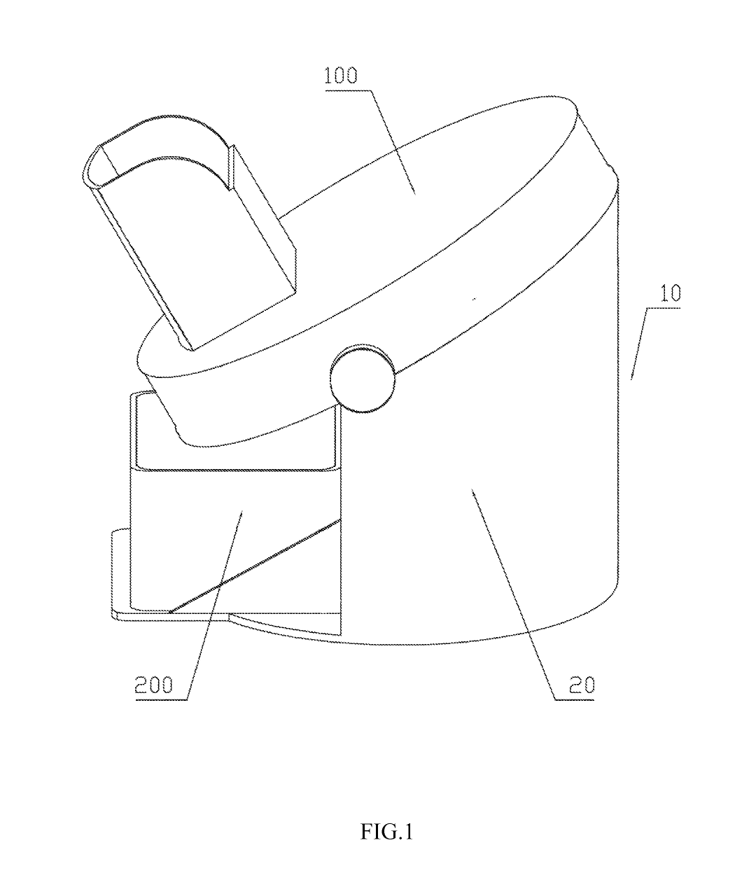

Referring initially to FIGS. 1, a food slicer according to the present disclosure is shown generally as food slicer 10. The food slicer 10 may include a lid 100 for covering the main body 20, a receptacle 200 for collecting the sliced food articles. The lid 100 may be selectively detachably connected to main body 20.

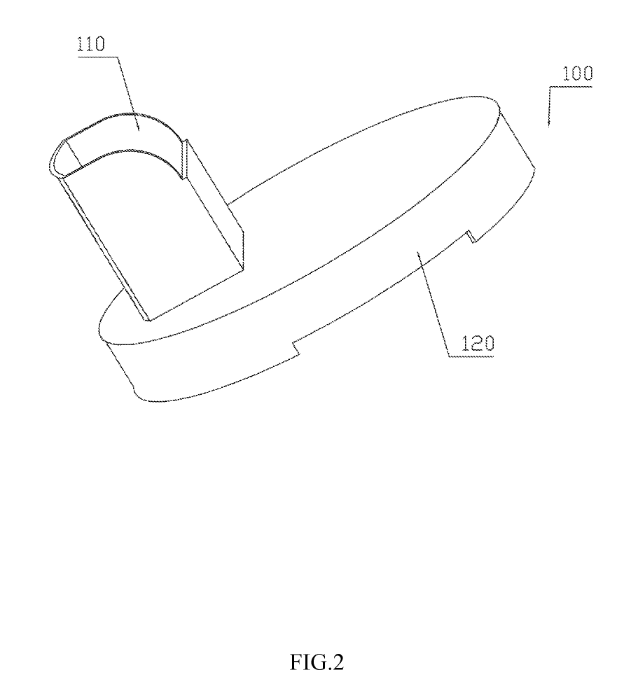

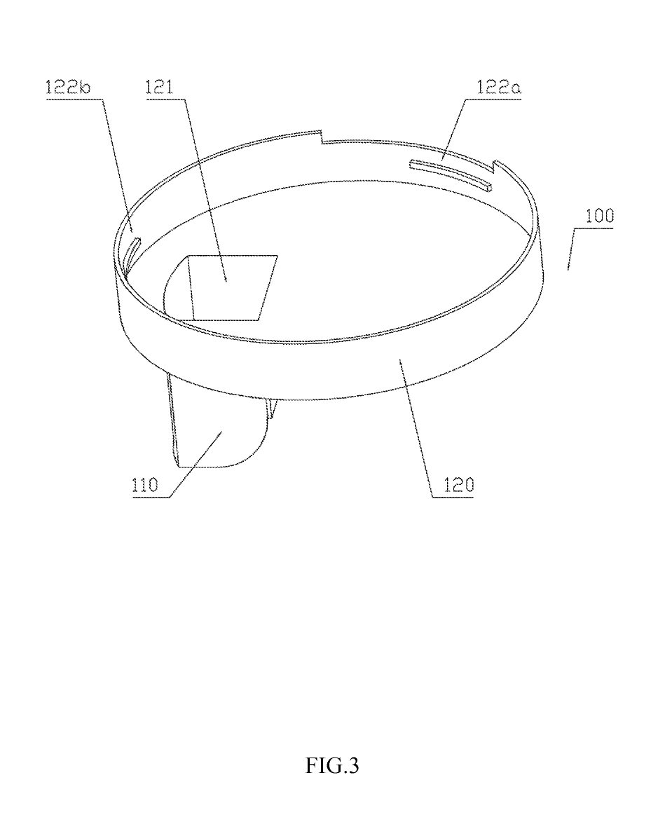

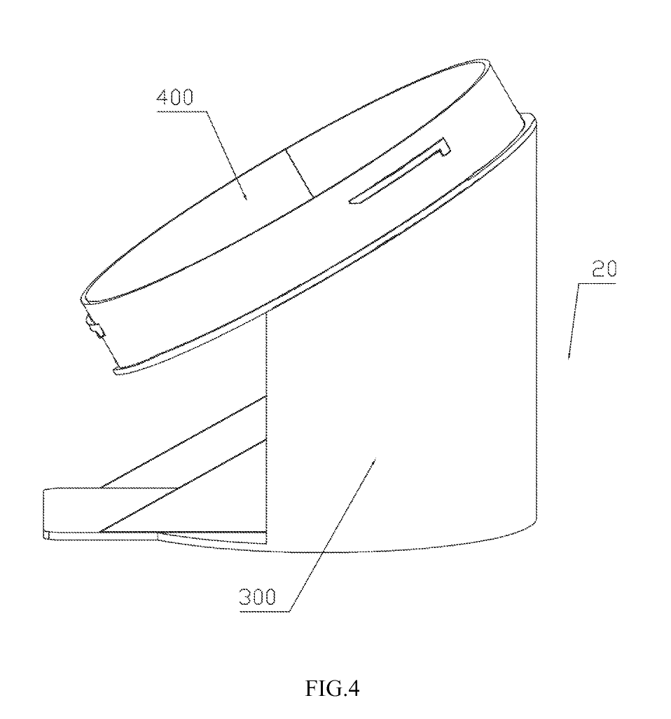

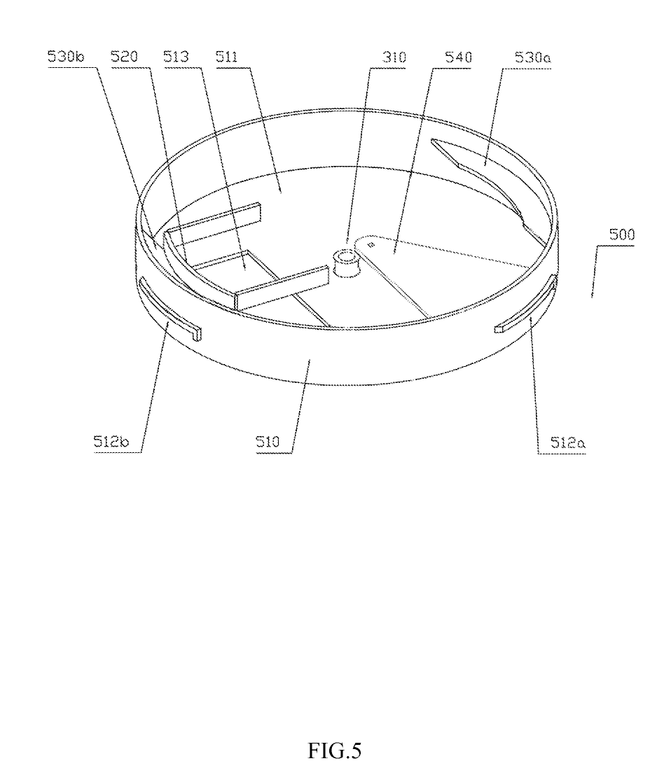

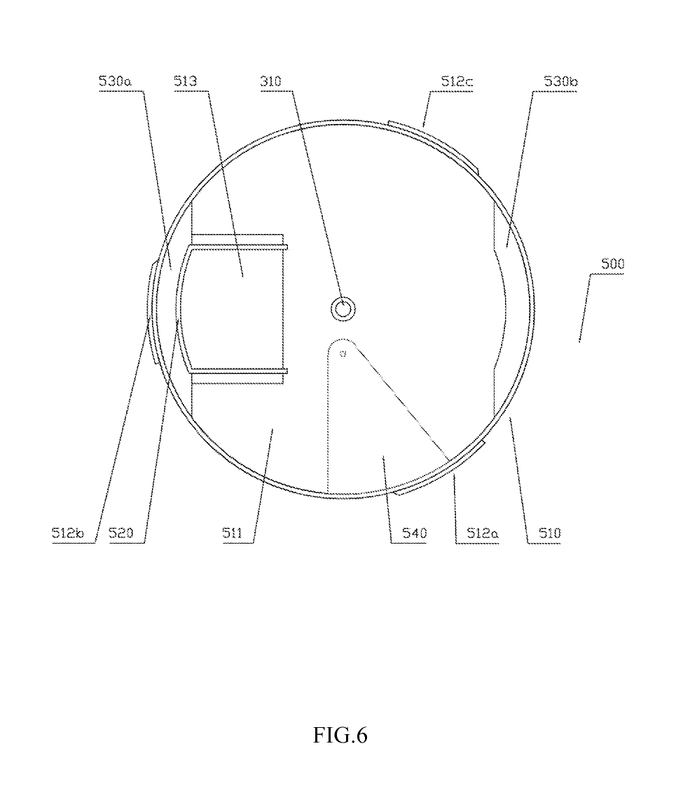

Turning now to FIGS. 2-3, lid 100 may be a substantially circular or cylinder body 120 having a planar surface and a downward extending lip around the periphery of the cylinder body 120 and sized and dimensioned to cover the upper part 400 of main body 20 (FIG. 4). Lid 100 may have a feed tube 110 extending upwards from the planar surface and may extend through an aperture 121 of the cylinder body 120 to connect with the cylinder body 120. The lid 100 includes a slit or a groove 122a and 122b configured for selective engagement with radial projections 510a, 510b, 510c formed on main body 20 (FIGS. 5-6).

As shown in FIGS. 2-3, feed tube 110 defines a substantially annular body having a substantially oval/rectangular cross-section. Feed tube 110 may cooperate with a pusher (not shown) to move smoothly in feed tube 110 to push the food articless through the feed tube 110.

Referring to FIGS. 4-5, the main body 20 includes base member 300 and upper part number 400. The base member 300 and upper part member 400 are operably connected to each other. The base member 300 may include a motor or other rotary drive mechanism (not shown) and may include controls (not shown) for varying the settings of the motor. As will be discussed in further detail below, the base member 300 may include a locking mechanism (not shown) for preventing food slicer 10 from activating the motor when lid 100 is not properly positioned on main body 20. The base member 300 may include additional features known in the art. Thus, the aspects of the present disclosure should not be read as limited by the configuration of the embodiment of the base member 300 as shown. The upper part member 400 of main body 20 may include a housing member 500 and the slicing device 30 mounted inside the housing member 500 where the housing member 500 is operably connected to the base member 300 and in

Referring to FIGS. 5-6, the housing 500 defines substantially a circular or cylinder body 510 with a bottom plate 511. The housing member 500 includes a slit or a groove 512a, 512b, 512c for selective engagement with lid 100. The housing 500 includes a locking mechanism (not shown) for preventing the food slicer 10 from activating the motor when the lid 100 is not properly positioned on housing 500. One suitable locking mechanism is disclosed in commonly assigned U.S. Pat. No. 7,063,283 to Wanat or commonly assigned U.S. Pat. No. 7,069,839 to Kernan, the entire contents of each disclosure being incorporated herein by reference.

As show in FIGS. 5 -6, the housing 500 includes a cutting board seat 520, a guide rail seat 530 and a slider assembly seat 540. The cutting board seat 520 may be mounted under the feed tube 110 to hold the cutting board 620 as discussed detail below. There is an opening 513 on the on the bottom 511 of circular body 510 to let the sliced food articles pass by. A drive shaft 310 of the motor may be mounted to a bottom 511 of the circular body 510 in the base member 300.

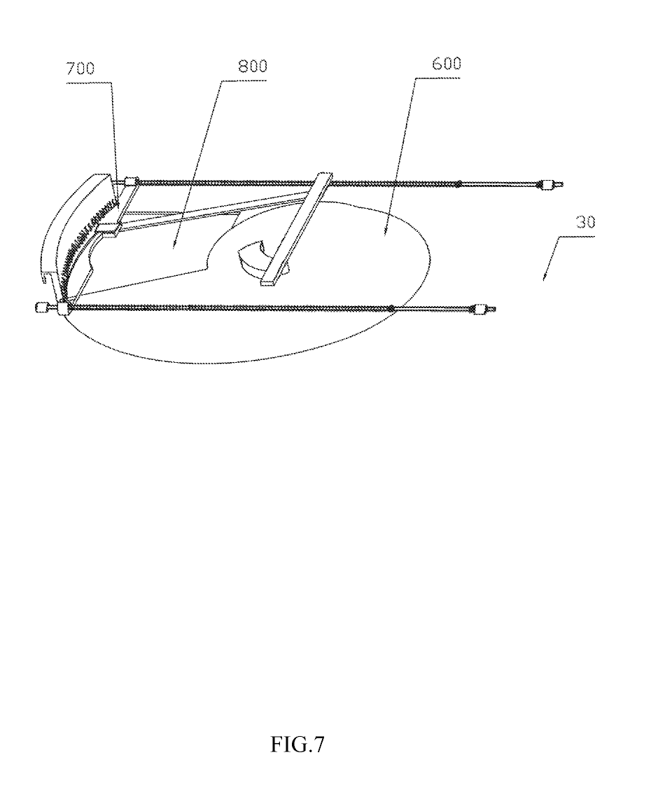

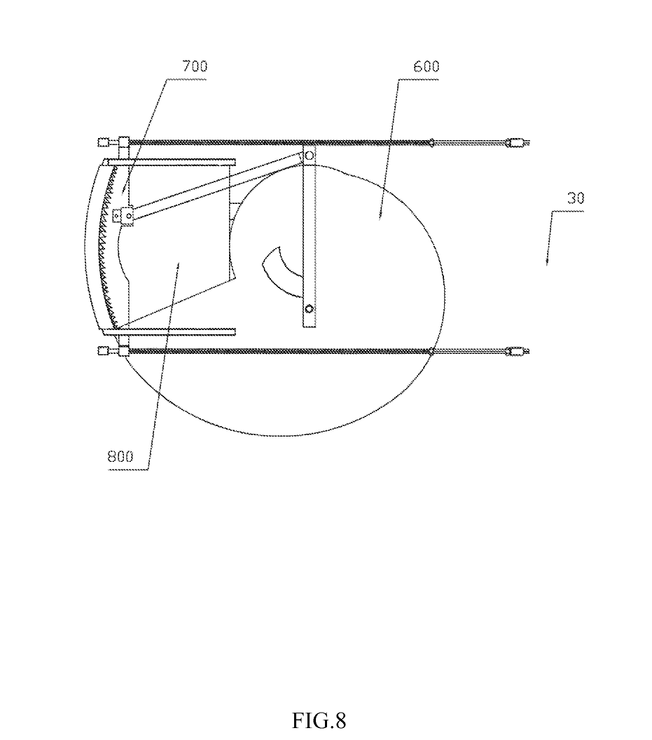

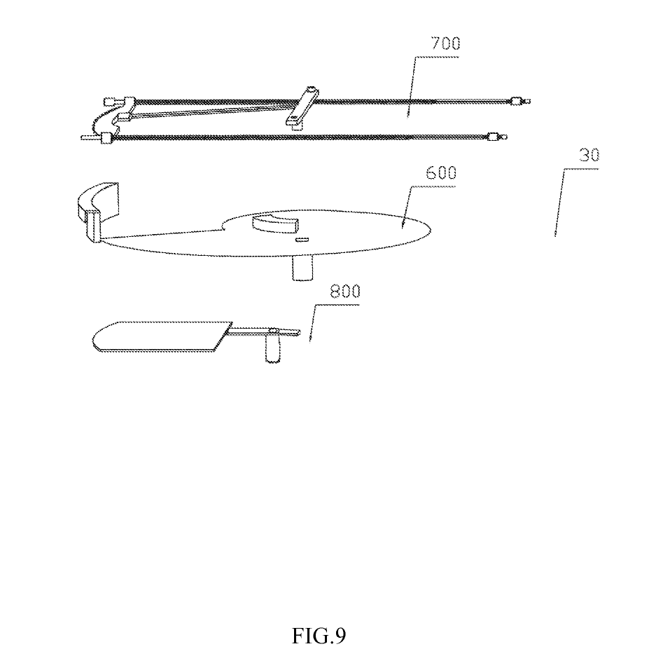

Referring to FIGS. 7-9, the slicing device 30 is mounted inside of the housing 500 and may include a cutting assembly member 600, slider assembly member 700 and supporting assembly member 800. The FIGS. 7-9 show the relative position of the cutting assembly member 600, the slider assembly member 700 and the supporting assembly member 800.

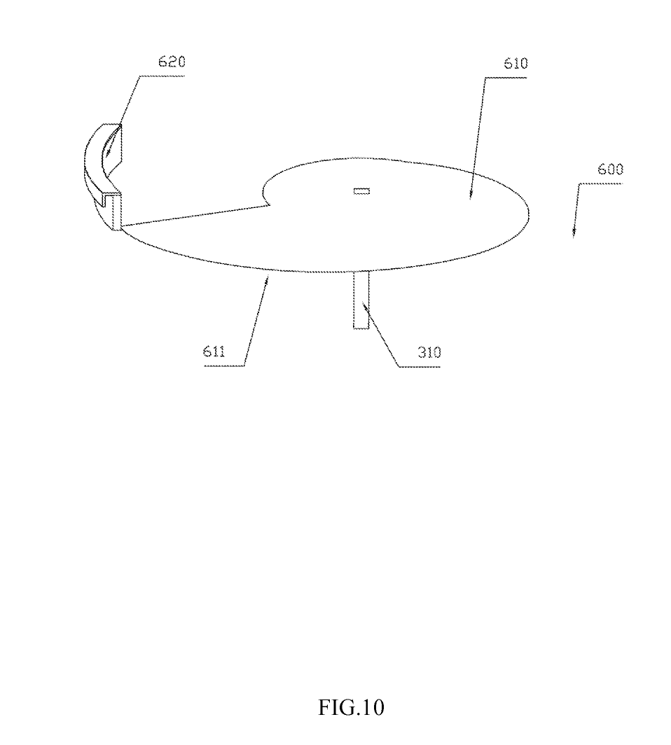

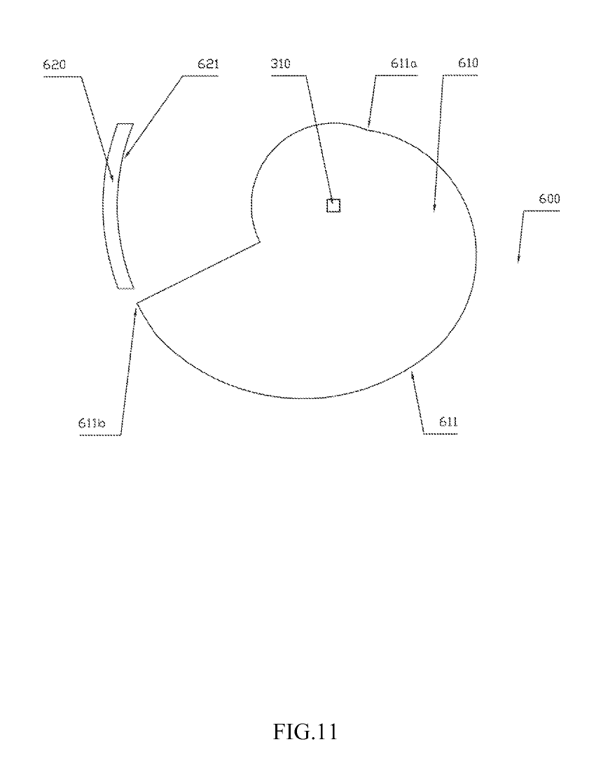

Referring to FIGS. 10-11, the cutting assembly member 600 may include a cutting blade 610 and a cutting board 620. The cutting blade 610 may be mounted on the drive shaft 310, and the planar surface of cutting blade 610 may be substantially vertical to the drive shaft 310. The distance of the cutting edge 611 of the cutting blade 610 to the drive shaft 310 increases progressively from 611a to 61 lb. The cutting board 620 may be mounted on the cutting board seat 520, and the curved cutting surface 621 of the cutting board 620 is aligned to the inner surface of feed tube 110 so that the food articles in feed tube 110 can slide smoothly onto the cutting surface 621 of the cutting board 620.

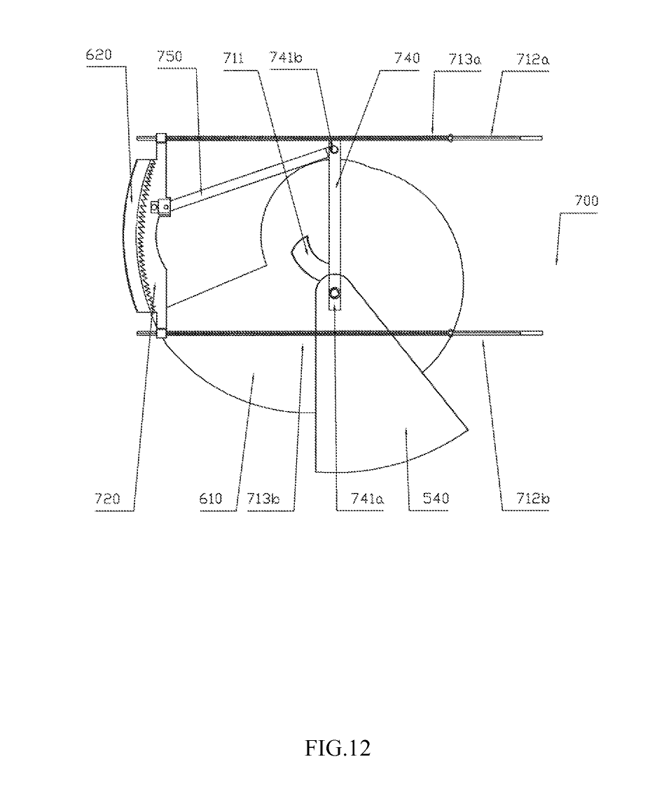

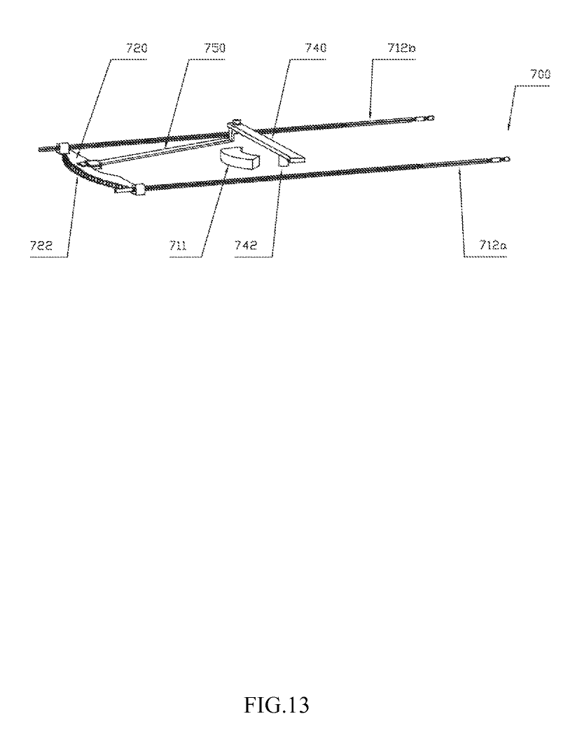

Referring to FIGS. 12-13, the slider assembly member 700 is an assembly to hold food articles on the cutting board 620 when the cutting blade 610 cuts the food articles, and releases the food articles to let the food articles slide down in the feed tube 110 when the cutting blade 610 finishes one cutting process. The slider assembly member 700 may include a block 711 which is mounted on the upper surface of the cutting blade 610, a guide rail which is oriented generally parallel to the cutting direction including a pair of opposing rods 712a and 712b mounted on the guide rail seat 530, a pair of opposing biasing devices such as a pair of opposing springs 713a and 713b to cooperate with the opposing rods 712a and 712b, a slider 720 slidable along the guide rail having a saw tooth edge 722 in order to hold the food articles on the cutting board, a rod 740 with one end pivotally mounted on the slider assembly seat 540 through a shaft 741 a and the other end pivotally connected with one end of a connection rod 750 through a shaft 741b, the other end of the connection rod 750 pivotally connected with the slider 720. There is a block 742 mounted on the rod 740 to cooperate with the block 711 on the cutting blade 610. The two opposing rods 712a and 712b may be substantially parallel to each other. The two rods 712a and 712b may be positioned above the surface of cutting blade 610 and substantially vertical to the driven shaft 310. The slider 720 has a saw tooth edge 722 to cooperate with an opposing edge of the cutting board 620 to hold food articles on cutting board 620. The two opposing springs 713a and 713b may be mounted on the two rods 712a and 712b respectively to propel the slider 720. The block 711 is mounted on the surface of cutting blade, so when the driven shift 310 drives the cutting blade to rotate (anticlockwise), the block 711 rotates with the cutting blade. The block 742 on the rod 740 is sized and dimensioned so that the block 711 can propel the block 742 up when the driven block 711 rotates to the position to contact with the block 742 on the rod 740, and since the rod 740 is connected with the slider through the connection rod 750, the block 711 lifts the slider up when the block 711 drives the block 742 up. When the block 711 on the cutting blade 610 rotates (anticlockwise) to the position to contact with the block 742, the block 711 lifts the slider 720 up through the connection rod 740 and the slider 720 moves away from cutting board 620 to release the food articles on the cutting board 620; when the block 711 rotates to the position to release the block 742, the springs 713a and 713b propel the slider 720 down adjacent to the cutting board 620 to hold the food articles on the cutting board 620.

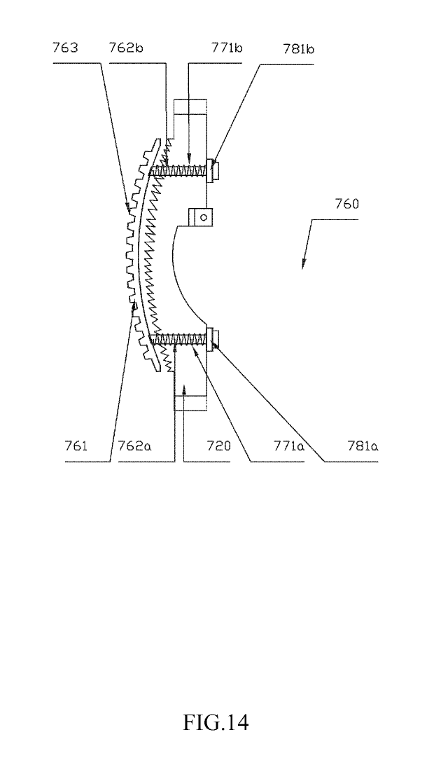

Referring to FIGS. 14, the slider assembly member 700 may also include an associate slider assembly 760 which is slidable along the cutting direction. The associate slider assembly 760 is to further hold the food articles on the cutting board when the cutting blade cuts the food articles. The associate slider assembly 760 may include a slider 761 with a pair of opposing rods 762a and 762b, a pair of opposing biasing devices such as a pair of opposing springs 771a and 771b to cooperate with the opposing rods 762a and 762b for propelling the slider 761. The two rods of the slider 761 passes through the two holes 781a and 781b of slider 720 so the slider 761 can only slide along the direction of rods 762a and 762b which is consistent with the cutting direction . The slider 761 also has a saw tooth edge 763 to cooperate with an opposing edge of the cutting board 620.

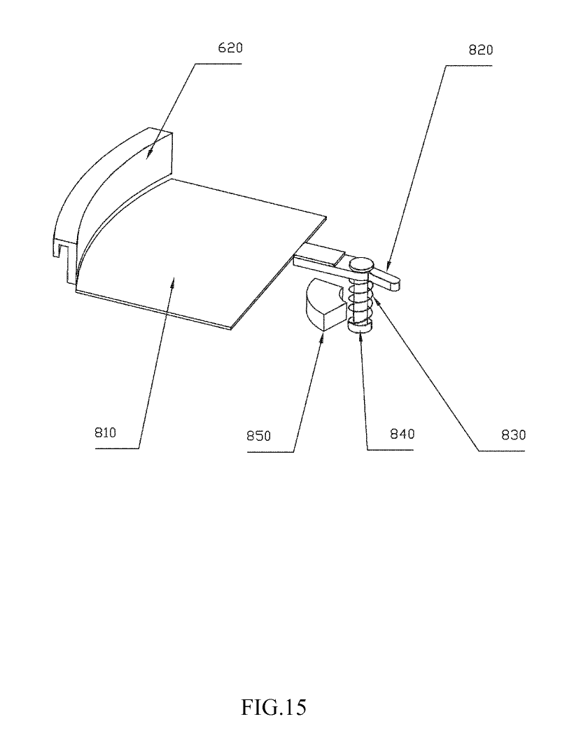

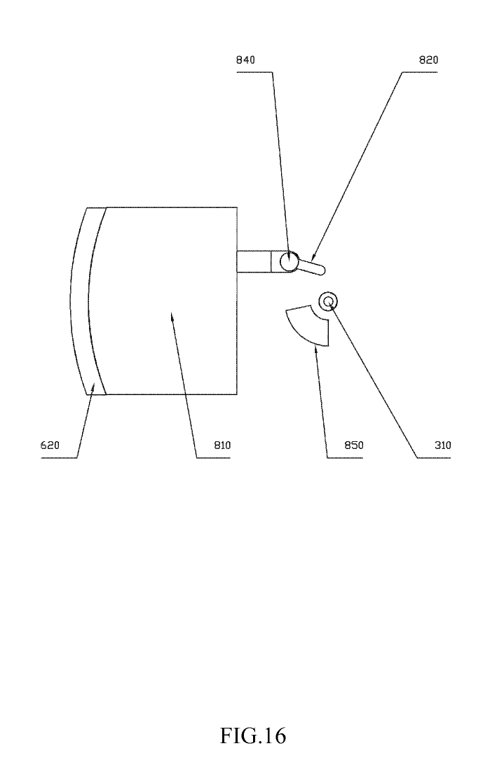

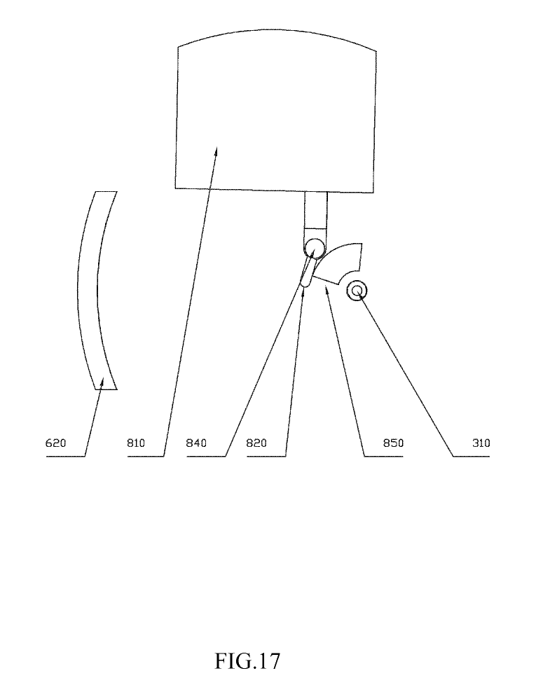

Referring to FIGS. 15-17, the supporting assembly 800 is to prevent the food articles from falling down when the cutting blade 610 cuts the food articles and to control the thickness of the sliced food articles. The supporting assembly may include a board 810 which is pivotally mounted on the housing through a shaft 840 with an arm 820, a spring 830 connected the housing 500 and the board 810, a block 850 mounted under the cutting blade 610 which rotates with the cutting blade 610 to drive the board 810 and cooperate with the arm 820. The spring 830 always intend to propel the board 810 to locate under the cutting board 620. When the cutting blade 610 rotates (anticlockwise) around the driven shaft 310 to the position where the block 850 contact with the arm 820, the block 850 drives the board 810 away from the cutting board 620 to let the sliced food articles fall down (the unsliced food articles is held by the slider 720); and when the cutting blade 610 rotates(anticlockwise) to the position where the block 850 releases the arm 820, the spring 830 drives the board 810 back to cutting board 620 to prevent the food articles on the cutting board 620 from falling down. The shaft 840 is parallel to the driven shaft 310, so the board 810 is parallel to the cutting blade 610. Once the food articles slide down in the feed tube 110 and seat on the board 810, the slider 720 slides down to hold the food articles on the cutting board 620 to prevent the food articles from moving until the cutting blade 610 cuts the food articles, so the sliced food articles is the food articles between the board 810 and the cutting blade 610, and the thickness of the sliced food is the distance between the board 810 and the cutting blade 610. When the mounted position of board 810 on the shaft 840 is adjusted, the distance between the cutting board 810 and the cutting blade 610 is changed, and so the thickness of the sliced food articles is adjusted.

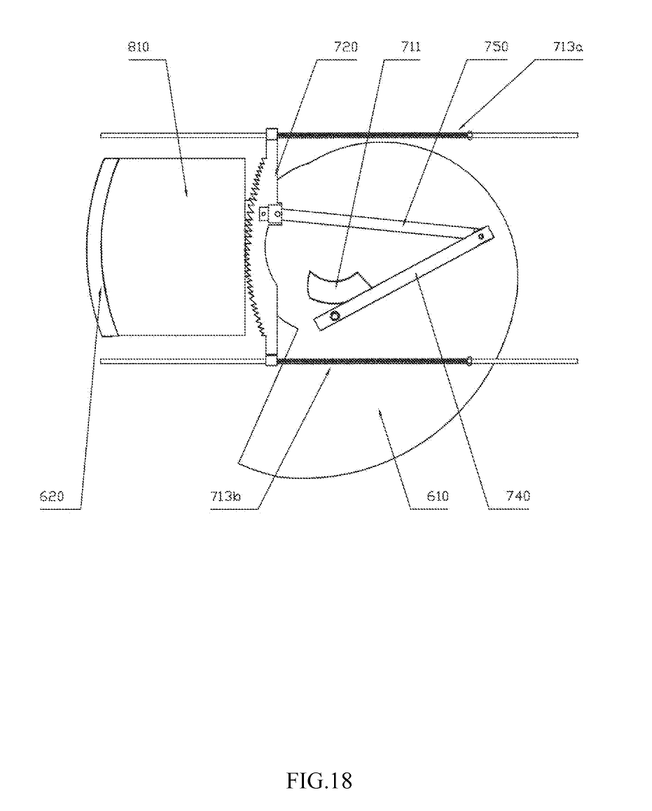

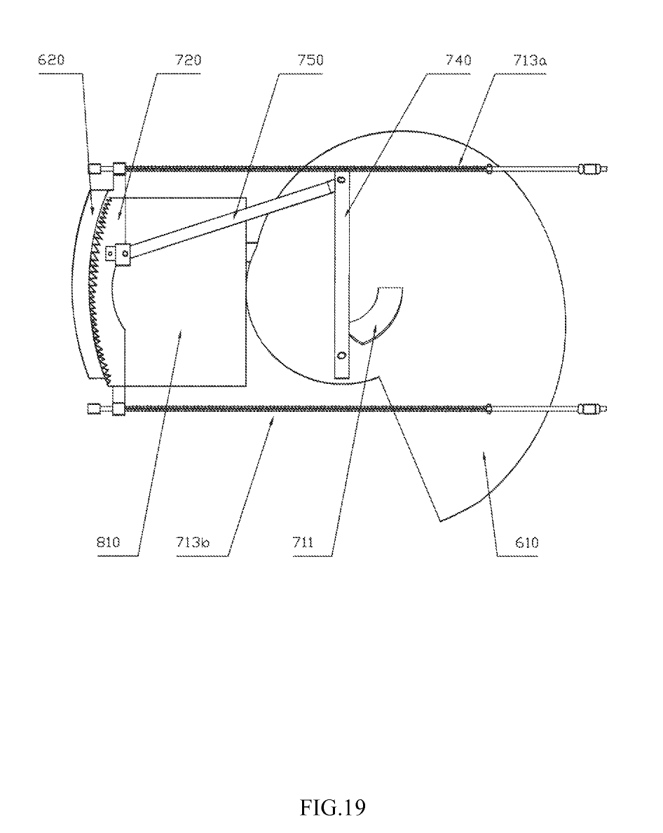

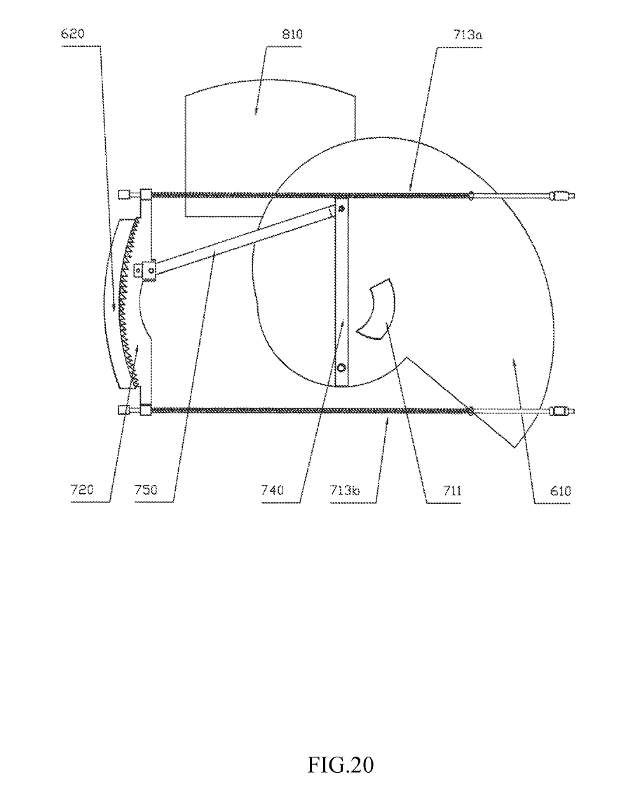

The cutting process of the food slicer can be described with the following four steps:
1. Referring to FIG. 18, to slice the food articles, the food articles are inserted into feed tube 110, the food articles slide down through the opening of cutting blade 610 and seat on the board 810 while the board 810 is located under the feed tube 110; at same time, the power device drives the cutting blade 610 to rotate (anticlockwise).
2. Referring to FIG. 19, when the cutting blade 610 rotates to the position where the block 711 on the surface of cutting blade 610 releases the block 742 on the rod 740, the springs 713a, 713b propel the slider 720 toward the cutting board 620 and hold the food articles on the cutting board 620.
3. Referring to FIG. 20, when cutting blade 610 rotates to the position where the arm 820 of the board 810 contacts with the block 850 which is mounted under the cutting blade 610, the board 810 is driven away from the bottom of feed tube 110; the cutting blade 610 begins to slice food articles on the cutting board 620 and once the a piece of food articles have been cut through, the sliced food articles fall down to the receptacle 200.
4. Referring to FIG. 18, when the cutting blade 610 rotates away from the cutting board 620, the block 850 releases the arm 820 of the board 810 and the spring 830 propels the board 810 back to the position under the cutting board 620; the cutting blade 610 keep rotating and the block 711 on the surface of cutting blade 610 lifts the slider 720 up and releases the food articles on the cutting board 620; the food articles on the cutting board 620 slide down and seat on the board 810 for the another cutting process.

This invention is not limited to cut food articles; it also can be used to slice or shred other materials. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A food slicer for slicing food, comprising:
a housing;
a cutting board with generally curved cutting surface mounted inside the housing;
a cutting blade oriented generally transverse to the cutting direction having a peripheral cutting edge and defining a blade plane;
an electric drive motor for drivingly rotating the cutting blade of the food slicer;
a first slider slidable along a first guide rail which is oriented generally parallel to the cutting direction;
a first spring connected between the first slider and the housing for propelling the first slider toward the cutting board,
whereby the first slider pushes the food articles toward the cutting board for preventing the food articles on the cutting board from moving.

2. A food slicer for slicing food as in claim 1 further including a lid for covering the housing, the lid defining a feed tube opening permitting access to within the housing;
a feed tube extending from a top wall of the lid, the feed tube defining a feed cavity and including a feed mouth;
a board pivotally mounted in the housing with surface oriented generically parallel to the blade plane for supporting the food articles;
a second spring connected between the board and the housing for propelling the board to rotate.

3. A food slicer for slicing food as in claim 2 further including a first block mounted on the top surface of the cutting blade for driving the first slider away from the cutting board and a second block mounted on the bottom surface of the cutting blade for driving the board.

4. A food slicer for slicing food as in claim 1 further including a second slider slidable along a second guide rail which is oriented generally parallel to the cutting direction and mounted on the first slider, and a third spring connected between the first slider and the second slider for propelling the second slider toward the cutting board.

5. A food slicer for slicing food as in claim 1, wherein the first slider has a saw tooth edge on the side of the cutting board.

6. A food slicer for slicing food as in claim 1, wherein the cutting blade has an opening for food articles passing over the cutting blade.

7. A food slicer for slicing food as in claim 2, wherein the board pivotally mounted on an axle, the axle is mounted in the housing, and the board is movable along the axle, whereby the distance between the cutting blade plane and the board is adjustable.

8. A food slicer for slicing food as in claim 1, wherein the cutting blade cooperates with a cutting board.

9. A food slicer for slicing food as in claim 4, wherein the second slider has a saw tooth edge.

10. A food slicer for slicing food as in claim 4, wherein second slider is a portion of a round circle.

11. A food slicer for slicing food as in claim 1 further including a receptacle.
